(19) United States
(12) Patent Application Publication
(10) Pub. No.: US 2022/0187998 A1
(43) Pub. Date: Jun. 16, 2022

(54) DATA STORAGE DEVICE AND METHOD CAPABLE OF CHAINING DATA INTO BLOCKCHAIN

(71) Applicant: INNODISK CORPORATION, NEW TAIPEI CITY (TW)

(72) Inventor: MING-SHENG CHEN, NEW TAIPEI CITY (TW)

(21) Appl. No.: 17/375,469

(22) Filed: Jul. 14, 2021

(30) Foreign Application Priority Data
Dec. 10, 2020 (TW) 109143735

(51) Int. Cl. G06F 3/06; H04L 9/06

(52) U.S. Cl. CPC G06F 3/0623; G06F 3/0659; H04L 2209/38; G06F 3/0683; H04L 9/0643; G06F 3/067

(57) ABSTRACT

The invention provides a data storage device, which comprises a data storage unit having a controller and a plurality of flash memories, a microprocessor, and a network communication component. A data chaining program is configured in the microprocessor or the controller. The data chaining program calculates a specific data stored in the flash memories by a hash algorithm to obtain a hash data corresponding to the specific data, and chains the hash data into a blockchain by the network communication component. Accordingly, the data storage device can chain the hash data corresponding to the specific data into the blockchain to ensure the security of the specific data in use.

This non-provisional application claims priority claim under 35 U.S.C. § 119(a) on Taiwan Patent Application No. 109143735 filed Dec. 10, 2020, the entire contents of which are incorporated herein by reference.

### FIELD OF THE INVENTION

The present invention is related to a data storage device, particularly to a data storage device capable of chaining data into blockchain.

### BACKGROUND

With the need for data storage, a data storage data, for example, solid state drive (SSD), often used by a computer host or an automatic device to store important data. Besides, the current Internet is flooded with malicious hackers. In order to achieve a specific purpose, some malicious hackers often invade the computer hosts of some government units or companies, and tamper with the data stored in the data storage devices of these computer hosts.

When the tampered data in the data storage device is the important commercial data (such as financial data, customer data, etc.), it will arise many problems if the tampered data is able to be not identified, and further used in transactions or personal information.

### SUMMARY

It is one objective of the present invention to provide a data storage device, wherein the data storage device is able to chain data into a blockchain in a cloud, so that the data in the data storage device can be protected in the blockchain based on the characteristics that the blockchain data cannot be tampered and forged.

It is other objective of the present invention to provide a data storage device, wherein the data storage device comprises a data storage unit having a controller and a plurality of flash memories, a microprocessor, and a network communication component. A data chaining program is configured in the microprocessor or the controller. The microprocessor or the controller executes the data chaining program in advance before the specific data is to be stored in the data storage device. The data chaining program calculates a specific data stored in the flash memories by a hash algorithm to obtain a first hash data, and uploads the first hash data to the blockchain via the network communication component so as to chain the first hash data into the blockchain. Afterwards, when the user desires to use the specific data stored in the flash memories, the chaining program calculates the current specific data by the hash algorithm to obtain the second hash data corresponding to the current specific data, and compares whether the second hash data is equal to the first hash data such that the authenticity of the specific data may be determined based on the comparison result. Accordingly, the security of the data of the data storage device in use can be ensured based on the characteristics that the blockchain data cannot be tampered and forged.

To achieve the above objective, the present invention provides a data storage device, comprising: a data storage unit comprising a plurality of flash memories and a controller connected to the flash memories; and a microprocessor connected to the data storage unit and a network communication component, wherein the data storage device is network connected to a blockchain via the network communication component, a data chaining program is configured in the microprocessor or the controller; wherein the data chaining program calculates a specific data to be stored to the flash memories or the specific data stored in the flash memories by a hash algorithm to obtain a first hash data corresponding to the specific data; then, the microprocessor uploads the first hash data to the blockchain via the network communication component so as to chain the first hash data into the blockchain.

In one embodiment of the present invention, wherein the flash memories are formed with a first data storage area and a second data storage area, the first data storage area is used for storing general data, the second data storage area is used for storing the specific data.

In one embodiment of the present invention, wherein the specific data is a data in a specific file format, or a data with a specific content.

In one embodiment of the present invention, wherein the data chaining program calculates the specific data in the flash memories by the hash algorithm again to obtain a second hash data, and downloads the first hash data corresponding to the specific data from the blockchain, and determines whether the specific data is tampered by comparing whether the second hash data is equal to the first hash data.

In one embodiment of the present invention, wherein the data chaining program uploads the specific data to the blockchain to chain the specific data into the blockchain.

In one embodiment of the present invention, wherein the microprocessor is configured with an embedded system for executing the data chaining program.

In one embodiment of the present invention, wherein the data storage device is a data storage device with a SATA transmission interface, a PCIe transmission interface, or a USB transmission interface.

In one embodiment of the present invention, wherein the network communication component is a WiFi communication component, an RJ45 communication component, or a 3G, 4G or 5G communication component.

The present invention further provides a method capable of chaining data into blockchain, which is adapted for a data storage device, wherein the data storage device comprises a data storage unit having a controller and a plurality of flash memories, a microprocessor, and a network communication component, a data chaining program is configured in the microprocessor or the controller, the method comprising: executing the data chaining program by the microprocessor or the controller; calculating a specific data to be stored to the flash memories or the specific data stored in the flash memories by a hash algorithm of the data chaining program to obtain a first hash data; and uploading the first hash data to the blockchain by the microprocessor via the network communication component to chain the first hash data into the blockchain.

In one embodiment of the present invention, further comprising a data authenticity verification procedure comprising: calculating the specific data in the flash memories again by the hash algorithm of the data chaining program to obtain a second hash data; downloads the first hash data corresponding to the specific data from the blockchain; and comparing whether the second hash data is equal to the first hash data to determine whether the specific data is tampered.

In one embodiment of the present invention, further comprising: uploading the specific data to the blockchain by the data chaining program to chain the specific data into the blockchain.

### BRIEF DESCRIPTION OF THE DRAWINGS

FIG. 1 is a structural view of a data storage device of the present invention.

FIG. 2 is a flow chart of a method for chaining data into blockchain of the present invention.

### DETAILED DESCRIPTION OF THE PREFERRED EMBODIMENTS

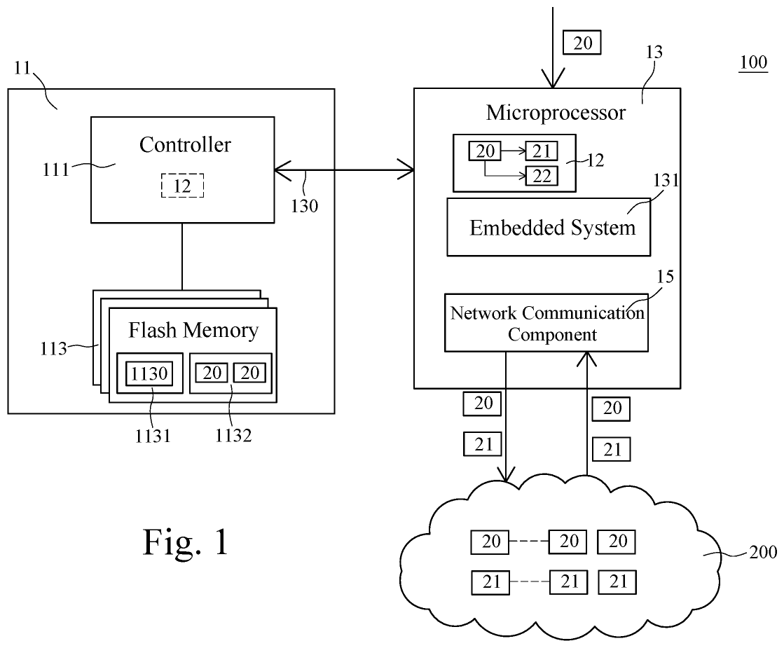

Referring to FIG. 1, there is shown a structural view of a data storage device of the present invention. As shown in FIG. 1, the data storage device 100 of the present invention is solid state disk (SSD) with a SATA transmission interface, a PCIe transmission interface, or a USB transmission interface, configured in an electronic device, for example, computer host or automatic device, and used as a data storage medium. The data storage device 100 comprises a data storage unit 11 and a microprocessor 13. The data storage unit 11 comprises a controller 111 and a plurality of flash memories 113. The controller 111 is connected to the flash memories 113.

The microprocessor 13 is connected to the controller 111 of the data storage unit 11 via a dedicated connection line 130. The connection line 130 may be a connection line conforming to an RS232 specification, a UART specification, or an I2C specification. In one embodiment of the present invention, the microprocessor 13 is a chip with a network communication function, for example, a network communication component 15 being integrated in the microprocessor 13. In other embodiment of the present invention, the microprocessor 13 and the network communication component 15 are independent components, respectively, and the microprocessor 13 is connected to the network communication component 15. The microprocessor 13 is connected to a blockchain 200 in cloud via the network communication component 15. Besides, the microprocessor 13 is configured with an embedded system 131 that is an architecture system of Linux or RTOS (such as TinyOS), and stored in non-volatile memories (NVMs).

The data storage device 100 further comprises a data chaining program 12. The data chaining program is configured in the microprocessor 13 or the controller 111 in a form of firmware, and executed by the microprocessor 13 or the controller 111. Otherwise, the data chaining program 12 is installed in the embedded system 131 of the microprocessor 13 in a form of software, and executed by the embedded system 131. Alternatively, the flash memories 113 of the data storage unit 11 is installed with an operating system 1130, the data chaining program 12 is installed in the operating system 1130 of the data storage unit 11 in the form of software, and is executed by the operating system 1130.

A specific data 20, for example, commercial data, confidential data, personal data or data in a specific format, etc., can be stored into the data storage device 100 via a data transmission interface of the data storage device 100. In one embodiment of the present invention, the microprocessor 13 or the controller 111 executes the data chaining program 12 in advance before the specific data 20 is to be stored in the data storage device 100. The data chaining program 12 calculates the specific data 20 by a hash algorithm to obtain a first hash data 21 corresponding to the specific data 20, and then uploads the first hash data 21 to the blockchain 200 via the network communication component 15 so as to chain the first hash data 21 into the blockchain 200. Accordingly, the first hash data 21 can be protected in the blockchain 200 according to the characteristics that the blockchain data cannot be tampered and forged. After the first hash data 21 is chained in the blockchain 200, the controller 111 writes the specific data 20 into the flash memories 113.

In other embodiment of the present invention, data sectors of the flash memories 113 are formed with a first data storage area 1131 and a second data storage area 1132. The first data storage area 1131 is used for storing general data, for example, operating system 1130 or application program, and the second data storage area 1132 is used for storing the specific data 20, for example, business document, license document, or confidential document. When the specific data 20 has stored in the second data storage area 1132, the microprocessor 13 or the controller 111 will automatic execute the data chain program 12. The data chaining program 12 calculates each specific data 20 in the data storage area 1132 by the hash algorithm to obtain each first hash data 21 corresponding to each specific data 20, and then uploads each first hash data 21 corresponding to each specific data 20 to the blockchain 200, respectively, via the network communication component 15 so as to chain each first hash data 21 corresponding to each specific data 20 into the blockchain 200. Accordingly, each first hash data 21 corresponding to each specific data 20 can be protected in the blockchain 200 based on the characteristics that the blockchain data cannot be tampered and forged.

In another embodiment of the present invention, the specific data 20 is a data in a specific file format of, for example, data in WORD file format, PDF file format, PPT file format, JPG file format, EXCEL file format, DWG file format, or other file format. When the microprocessor 13 or the controller 111 knows that the data 20 in the format of specific file is to be stored to the flash memories 113, or has stored in the flash memories 113 according to the analyzation of the file extension of the data 20, the microprocessor 13 or the controller 11 will automatic execute the data chaining program 12. The data chaining program 12 calculates the data 20 in the specific file format by the hash algorithm to obtain the first hash data 21 corresponding to the data 20 in the specific file format, and then uploads the first hash data 21 corresponding to the data 20 in the specific file format to the blockchain 200 via the network communication component 15 so as to chain the first hash data 21 corresponding to the data 20 in the specific file format into the blockchain 200. Accordingly, the first hash data 21 corresponding to the data 20 in the specific file format can be protected in the blockchain 200 based on the characteristics that the blockchain data cannot be tampered and forged.

In another embodiment of the present invention, the specific data 20 is a data with a specific content, for example, business contract data, license document data or basic personal data. When the microprocessor 13 or the controller 111 knows that the data 20 with the specific content is to be stored to the flash memories 113, or has stored in the flash memories 113 by analyzing the content of the data 20 according to one or more key words, the microprocessor 13 or the controller 11 will automatic execute the data chaining program 12. The data chaining program 12 calculates the data 20 with the specific content by the hash algorithm to obtain the first hash data 21 corresponding to the data 20 with the specific content, and then uploads the first hash data 21 corresponding to the data 20 with the specific content to the blockchain 200 via the network communication component 15 so as to chain the first hash data 21 corresponding to the data 20 with the specific content into the blockchain 200. Accordingly, the first hash data 21 corresponding to the data 20 with the specific content can be protected in the blockchain 200 based on the characteristics that the blockchain data cannot be tampered and forged.

Before the specific data 20 stored in the flash memory 113 wants to be used as a proof, transaction or other specific requirements, the data chaining program 12 will execute a data authenticity verification procedure. In the data authenticity verification procedure, the data chaining program 12 calculates the current specific data 20 in the flash memories 113 by the hash algorithm again to obtain a second hash data 22, downloads the first hash data 21 corresponding to the specific data 20 from the blockchain 200 in cloud, and then compares whether the second hash data 22 is equal to the first hash data 21. If the data chaining program 12 determines that the second hash data 22 is equal to the first hash data 21, the specific data 20 is an original data that does not tampered with. On the contrary, if the data chaining program 12 determines that the second hash data 22 is not equal to the first hash data 21, the specific data 20 is an original data that has been tampered with.

As the above described, the data storage device 100 of the present invention chains the first hash data 21 corresponding to the specific data 20 into the blockchain 200; afterwards, when the user desires to use the current specific data 20 in the flash memories 113 of the data storage device 100, the chaining program 12 of the data storage device 100 calculates the current specific data 20 by the hash algorithm to obtain the second hash data 22 corresponding to the current specific data 20, and compares whether the second hash data 22 is equal to the first hash data 21 so that the authenticity of the specific data 20 may be determined according to the comparison result to ensure the security of the specific data 20 in use.

Further, the data storage device 100 uploads the original specific data 20 to the blockchain 200 via the data chaining program 12 so as to chain the original specific data 20 into the blockchain 200. When the specific data 20 is tampered with or damaged, the user of the data storage device 100 can download the original specific data 20 from the blockchain 200 to ensure the integrity of the data in the data storage device 100.

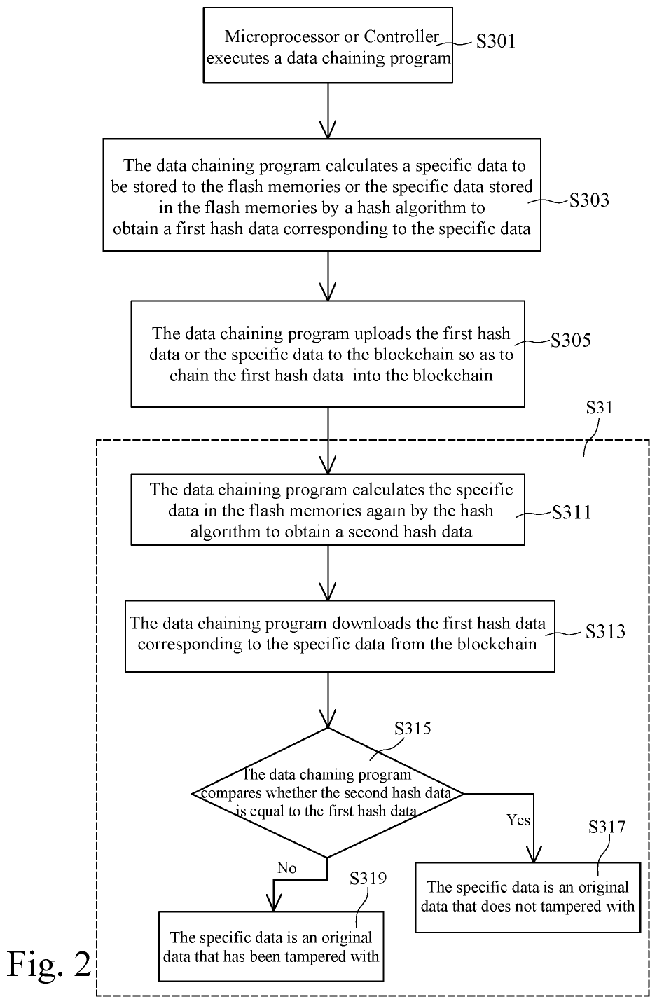

Referring to FIG. 2, there is shown a flow chart of a method for chaining data into blockchain of the present invention. As shown in FIG. 2, firstly, in step S301, the data chaining program 12 is executed by the microprocessor 13 or the controller 11. In step S303, the data chaining program 12 calculates the specific data 20 to be stored to the flash memories 113 or the specific data 20 stored in the flash memories 113 by the hash algorithm to obtain the first hash data 21 corresponding to the specific data 20. In step S305, the data chaining program 12 uploads the first hash data 21 to the blockchain 200 via the network communication component 15 so as to chain the first hash data 21 into the blockchain 200. In one embodiment of the present invention, in addition to uploading the first hash data 21 to the blockchain 200, the data chaining program 12 also uploads the specific data 20 corresponding to the first hash data 21 to the blockchain 200 at the same time.

Afterwards, a data authenticity verification procedure S31 will be executed by the data chaining program 12 before the user wants to use the specific data 20 in the flash memory 113. In the step S311 of the data authenticity verification procedure S31, the data chaining program 12 calculates the specific data 20 in the flash memories 113 again by the hash algorithm to obtain the second hash data 22. In the step S313, the data chaining program 12 downloads the first hash data 21 corresponding to the specific data 20 from the blockchain 200. In the step S315, the data chaining program 12 compares whether the second hash data 22 is equal to the first hash data 21; if yes, performing to step S317, the data chaining program 12 determines that the specific data 20 is an original data that does not tampered with; if not, performing to step S319, the data chaining program 12 determines that the specific data 20 is an original data that has been tampered with.

The above disclosure is only the preferred embodiment of the present invention, and not used for limiting the scope of the present invention. All equivalent variations and modifications on the basis of shapes, structures, features and spirits described in claims of the present invention should be included in the claims of the present invention.

What is claimed is:

1. A data storage device, comprising:
a data storage unit comprising a plurality of flash memories and a controller connected to the flash memories; and
a microprocessor connected to the data storage unit and a network communication component, wherein the data storage device is network connected to a blockchain via the network communication component, a data chaining program is configured in the microprocessor or the controller;
wherein the data chaining program calculates a specific data to be stored to the flash memories or the specific data stored in the flash memories by a hash algorithm to obtain a first hash data corresponding to the specific data; then, the microprocessor uploads the first hash data to the blockchain via the network communication component so as to chain the first hash data into the blockchain.

2. The data storage device according to claim 1, wherein the flash memories are formed with a first data storage area and a second data storage area, the first data storage area is used for storing general data, the second data storage area is used for storing the specific data.

3. The data storage device according to claim 1, wherein the specific data is a data in a specific file format, or a data with a specific content.

4. The data storage device according to claim 1, wherein the data chaining program calculates the specific data in the flash memories by the hash algorithm again to obtain a second hash data, and downloads the first hash data corresponding to the specific data from the blockchain, and determines whether the specific data is tampered by comparing whether the second hash data is equal to the first hash data.

5. The data storage device according to claim 1, wherein the data chaining program uploads the specific data to the blockchain to chain the specific data into the blockchain.

6. The data storage device according to claim 1, wherein the microprocessor is configured with an embedded system for executing the data chaining program.

7. The data storage device according to claim 1, wherein the data storage device is a data storage device with a SATA transmission interface, a PCIe transmission interface, or a USB transmission interface.

8. The data storage device according to claim 1, wherein the network communication component is a WiFi communication component, an RJ45 communication component, or a 3G 4G or 5G communication component.

9. A method capable of chaining data into blockchain, which is adapted for a data storage device, wherein the data storage device comprises a data storage unit having a controller and a plurality of flash memories, a microprocessor, and a network communication component, a data chaining program is configured in the microprocessor or the controller, the method comprising:
executing the data chaining program by the microprocessor or the controller;
calculating a specific data to be stored to the flash memories or the specific data stored in the flash memories by a hash algorithm of the data chaining program to obtain a first hash data; and
uploading the first hash data to the blockchain by the microprocessor via the network communication component to chain the first hash data into the blockchain.

10. The method according to claim 9, further comprising a data authenticity verification procedure comprising:
calculating the specific data in the flash memories again by the hash algorithm of the data chaining program to obtain a second hash data;
downloads the first hash data corresponding to the specific data from the blockchain; and
comparing whether the second hash data is equal to the first hash data to determine whether the specific data is tampered.

11. The method according to claim 9, further comprising:
uploading the specific data to the blockchain by the data chaining program to chain the specific data into the blockchain.
